(19) United States
(12) Patent Application Publication
(10) Pub. No.: US 2024/0280126 A1
(43) Pub. Date: Aug. 22, 2024

(54) DEVICE FOR COMPENSATING FOR TOLERANCES BETWEEN TWO COMPONENTS TO BE CONNECTED TO ONE ANOTHER

(71) Applicant: Witte Automotive GmbH, Velbert (DE)

(72) Inventors: Jan Christian BENTE, Sprockhövel (DE); Karin SYCHA, Velbert (DE); Harry PURWIN, Ratingen (DE); Vladimir RADANOVIC, Köln (DE)

(21) Appl. No.: 18/437,417

(22) Filed: Feb. 9, 2024

(30) Foreign Application Priority Data
Feb. 17, 2023 (DE) 10 2023 201 410.6

(51) Int. Cl. F16B 5/02; F16B 43/00

(52) U.S. Cl. CPC F16B 5/025; F16B 43/00

(57) ABSTRACT

A device for compensating for tolerances between two components to be connected to one another may have a hollow-cylindrical base element and a hollow-cylindrical compensating element which can be brought or is brought into threaded engagement with the base element. The base element and the compensating element are set up such that they can be moved relative to one another between an initial position and a compensating position and can optionally be pivoted with one another.

### FIELD

The invention relates to a device for compensating for tolerances between two components to be connected to one another.

### Background

Tolerance compensation devices are generally known and are part of fastening elements for fastening components and parts to one another—in particular, in motor vehicles. For example, tolerance compensation devices or elements are known that are used for example in vehicle construction—in particular, when two components need to be screwed together across a joint gap that has a tolerance. For this purpose, the tolerance compensation device is arranged between the components to be connected, and a screw element for screwing together the components, e.g., a screw or threaded bolt, is passed through correspondingly provided openings in the parts and through the tolerance compensation device. When screwing the screw element, the compensating element is rotated relative to the base element by means of a driving spring connected between the screw element and the compensating element and is thus moved out of its starting position axially to the base element; for example, it is moved out of the base element until it reaches its compensating position, in which the base element and the compensating element each lie against one of the components and thus bridge the joint gap.

The invention is based upon the object of providing a particularly simply constructed device for compensating for tolerances between two components to be connected to one another, in which an angle between the components can also be adjusted and/or compensated for.

The object is achieved according to the invention by a device with the features of the claims described herein for compensating for tolerances between two components to be connected to one another.

Advantageous developments of the invention are the subject matter of the dependent claims.

### SUMMARY

The device according to the invention for compensating for tolerances between two components to be connected to one another comprises at least one hollow-cylindrical base element and a hollow-cylindrical compensating element which can be brought or is brought into threaded engagement with the base element, wherein the base element and the compensating element are set up such that they can be moved relative to one another between an initial position and a compensating position and can optionally be pivoted with one another.

For example, the base element and the compensating element can be pre-mounted on one of the components to be connected and can be movable—in particular, pivotable-relative to the other of the two components to be connected. The base element and the compensating element are designed to be pivotable together, and thus with one another, i.e., as a common compensating unit.

Both elements, the base element and the compensating element, furthermore have a first—in particular, an inner—interface by means of which the two elements, the base element and the compensating element, can be moved relative to one another—in particular, can be moved linearly relative to one another. The first interface can be designed as a thread, for example. In particular, the base element and the compensating element have corresponding threads. For example, the base element can have an internal thread and the compensating element an external thread, or, conversely, the base element can have an external thread and the compensating element an internal thread.

In addition, one of the elements—in particular, the base element or the compensating element—can have a second—in particular, a common outer—interface by means of which the two elements, the base element and the compensating element, can be mounted so as to be pivotable together. The second interface can be designed, for example, as a joint—in particular, as a ball joint—or a rotary bearing—in particular, a ball bearing.

The advantages achieved with the invention consist in particular in the fact that an angle between the components to be connected can be adjusted and compensated for in addition to the tolerance compensation—for example, an axial tolerance compensation. The device is, for example, a tolerance compensation device with an integrated angle compensation device. The device enables a combined module consisting of an axial tolerance compensation device with an integrated joint—for example, a spherical joint, such as a ball joint. Such a joint can have a joint head and a joint socket in order to provide a pivotability of the compensating unit made up of the base element and the compensating element. The base element or the compensating element can have a spherical segment or a spherical cap.

The device according to the invention is constructed in a particularly simple manner from a small number of parts and is inexpensive to manufacture. This results in a reduction in the complexity when assembling the device. The angle compensation or an angle adjustment between the components can take place before or after connecting the two components.

Compared to conventional tolerance compensation devices, the device according to the invention—in particular, the tolerance compensation device-makes it possible to compensate for at least an axial play between two components when fastening the two components, and optionally also a radial play between components of the pre-mounting unit, as well as to compensate for and/or adjust an angle between the two components.

The base element or the compensating element can have a bulge, e.g., a convex bulge, on an outer circumference. The convex bulge can be formed circumferentially over the outer circumference. The base element or the compensating element can have a convex outer shape and a cylindrical inner shape. For example, the cylindrical inner shape of the base element can have an internal thread which is or is brought into engagement with an external thread of the compensating element. In other words, the base element or the compensating element can have a spherical outer shape or outer surface.

In an embodiment in which the compensating element can be or is arranged on the outside of the base element, the compensating element can have a convex outer shape and a cylindrical inner shape with internal thread. Here, the base element can have an external thread which can be or is brought into engagement with the inner thread of the compensating element.

It is to be understood that, depending upon the design of the device, either the compensating element is arranged in the base element, or the base element is arranged in the compensating element, wherein the corresponding external element is pivotably mounted on one of the components to be connected. Accordingly, the external element has a corresponding convex outer shape or a corresponding convex segment. The corresponding component can be provided with a bearing element which has a corresponding concave inner shape for the sliding, pivotable receptacle of the convex outer shape or the segment. For example, the bearing element—in particular, its bearing opening—can have an indentation—in particular, a concave indentation.

The base element can be designed in one piece—for example, in one part. The compensating element can be designed in one piece—for example, in one part. The base element and/or the compensating element can be formed of metal and/or plastic, at least in portions.

The base element or the compensating element can be provided on an outer circumference at least in portions with a convexly formed segment, which is designed in such a way that the base element or the compensating element is pivotably mountable or mounted on one of the components in order to adjust and/or compensate for an angle between them. For example, the convexly formed segment is a spherical segment or a spherical cap. A corresponding bearing element and/or one of the two components can have a joint segment, e.g., a socket—in particular, a ball socket or joint socket. The convexly formed segment can be designed to run around the outer circumference of the base element or of the compensating element.

The convexly formed segment can be integrally formed on the outer circumference of the base element or on the outer circumference of the compensating element. The base element and/or the compensating element can be made of metal. For example, the base element or the compensating element can be provided with the convexly formed segment using a suitable shaping method or a suitable shaping technique. Since the outer circumference or an outer shape of the basic element or of the compensating element is designed to be pivotable, ball joint devices known from the prior art, such as nut elements with ball sockets or conical sockets, separate ball washers or ball sockets, additional ball pins or screws with joint connectors, are not required, so that the number of components of the device is reduced.

For example, the convexly formed segment can be injection-molded on the base element or the compensating element. For example, the convexly formed segment can be glued to the outer circumference. Some other materially bonded connection may also be used.

The base element or the compensating element can be provided with a separate retaining ring which can have a convexly formed segment and can be designed in such a way that the base element or the compensating element is pivotably mountable or mounted on one of the components. The base element or the compensating element can be pressed into the retaining ring. Some other force-fitting, positive-fitting, and/or materially bonded connection may also be used. The retaining ring and the base element or the retaining ring and the compensating element can be connected to each other. The base element or the compensating element can be inserted in a cylindrical receiving space in the retaining ring.

The retaining ring can have a convex outer shape. The retaining ring can have a cylindrical inner shape which can be connectable or connected to the outer shape or outer surface of the base element or of the compensating element.

In a corresponding bearing element, the base element or the compensating element is or can be arranged in a sliding, pivotable manner on one of the components. The base element, the compensating element, and the integrated pivoting capability, and optionally also the bearing element, can be pre-mounted to form a pre-mounting unit. The bearing element can already be pre-mounted on one of the components to be connected or can be pre-mounted together with the base element and the compensating element on one of the components to be connected. Via the pre-mounting unit, this component is then connected, e.g., releasably connected, to the other of the components to be connected. In a development, the bearing element and the corresponding component can be designed in one part—for example, in one piece.

The bearing element can have at least one recess with a concave inner shape. The bearing element can have the concave inner shape for pivotable connection to the base element or the compensating element. The bearing element can thus have a joint socket—for example, a spherical socket or ball socket.

The device comprises a connecting element, e.g., a screw element, which can be inserted through the base element and the compensating element in order to connect the two components. For example, a connecting element, such as a screw, can form a pre-mounting unit together with the base element and the compensating element, and optionally also with the bearing element.

The thread engagement between the base element and the compensating element can be non-self-locking in such a way that the compensating element moves out of the base element in an insertion direction or screw-in direction of the connecting element, e.g., a connecting screw, when the connecting element exerts an axial force acting in the insertion direction upon the compensating element.

The base element can comprise a steep thread. The compensating element can comprise a steep thread. The base element forms an internal thread. The compensating element forms an external thread. Due to the non-self-locking design of the threads of the base element and the compensating element, a mere axial force, e.g., exerted by the connecting element, can be sufficient to unscrew the compensating element from the base element. In other words, the non-self-locking thread engagement ensures the conversion of a longitudinal movement, e.g., caused by the advance of the connecting element, into a rotary movement of the compensating element. This can happen, for example, in that a head of the connecting element is brought into contact with the compensating element when it is pushed through the device—in particular, the tolerance compensation device—and entrains it. Alternatively, a torque can be transmitted from the connecting element by means of a driver element, e.g., spring element, provided in and/or on the compensating element. The driver element is used to produce a frictional connection between the connecting element and the compensating element. The driver element can be arranged in an inner cavity of the compensating element and be in frictional engagement with the connecting element guided through the cavities of the base element and the compensating element in such a way that a torque exerted by the connecting element can be transmitted to the compensating element. Alternatively, a conventional fastening nut can be used, which is firmly connected to one of the components.

In a development, an outer circumference of the base element or an outer circumference of the compensating element can be provided with at least one securing element which is designed to hold the base element or the compensating element in non-rotational fashion on one of the components. For example, the securing element can be designed as a lug or bolt projecting radially from the outer shape or from the outer circumference of the base element or the compensating element. The bearing element can have at least one counter-securing element which is arranged and designed to engage with the securing element on an inner shape of the bearing element. For example, the counter-securing element can be designed as an opening, groove, or recess. Alternatively, the securing element can be designed as an opening, groove, or recess, and the counter-securing element as a lug or bolt.

At one of its longitudinal ends, the compensating element can comprise at least one transport securing means for securing the compensating element to the base element and/or to a convex outer shape of the base element and/or to a convexly formed segment on the base element. For example, the transport securing means can be formed as a molding, e.g., an annular rib or rib segments, which projects radially from the outer circumference in some portions. In a transport state, the compensating element and the base element can be completely or almost completely screwed to one another. A stop region can be formed at one end, facing away from the base element—in particular, the longitudinal end, of the compensating element. For example, a lug can be formed on the compensating element and/or on the stop region of the compensating element, wherein the lug engages in an opening on the base element in the transport state. The opening can be formed by a protruding end stop and a protruding transport securing element. The transport securing element serves as a transport securing means which prevents unintentional rotation of the compensating element relative to the base element. The transport securing element can be flexible in its design and, with a screw force applied to the compensating element, can be deformed, e.g., bent away, by the lug. Thus, after a defined torque or force has been overcome, the compensating element can be unscrewed from the base element.

### DESCRIPTION OF THE FIGURES

Exemplary embodiments of the invention are explained in more detail with reference to the drawings, in which:

FIG. 1 is a schematic exploded view of an embodiment of a device for compensating for tolerances between two components to be connected to one another, wherein the device has at least one base element, one compensating element, and one bearing element, wherein the bearing element is pre-mounted on one of the components,

FIG. 2 schematically shows the exploded view according to FIG. 1 in section,

FIG. 3 schematically shows, in section, the device according to FIG. 1 in a pre-mounted and/or assembled state,

FIG. 4 schematically shows, in section, an assembly step for aligning the device according to FIG. 1 with the other of the two components,

FIG. 5 schematically shows, in section, an intermediate position of the device according to FIG. 1 for connecting the two components and an assembly step in which an angle between the components is set and/or compensated for,

FIG. 6 schematically shows, in section, a final assembly position of the device according to FIG. 1, with both components connected to each other and aligned at an angle to each other,

FIG. 7 schematically shows, in a perspectival view, a further embodiment of a device for compensating for tolerances between two components to be connected to one another, wherein the device has at least one base element, one compensating element, and one bearing element, wherein the bearing element is pre-mounted on one of the components,

FIG. 8 schematically shows, in section, the device according to FIG. 7 with a pre-mounted connecting element,

FIG. 9 schematically shows, in an exploded view, a further embodiment of a device for compensating for tolerances between two components to be connected to one another, wherein the device has at least one base element, one compensating element, and one bearing element, wherein the bearing element is pre-mounted on one of the components,

FIG. 10 schematically shows, in section, the device according to FIG. 9 in a pre-mounted and/or assembled state,

FIG. 11 schematically shows, in section, an assembly step for aligning the device according to FIG. 9 with the other of the two components,

FIG. 12 schematically shows, in section, a final assembly position of the device according to FIG. 9, wherein both components are connected to each other and aligned at an angle to each other,

FIG. 13 schematically shows, in a perspectival view, a further embodiment of a device for compensating for tolerances between two components to be connected to one another, wherein the device has at least one base element, one compensating element, and one transport securing means,

FIG. 14 schematically shows, in section, the device according to FIG. 13 with a separate retaining ring,

FIG. 15 schematically shows, in an exploded view, a further embodiment of a device for compensating for tolerances between two components to be connected to one another, wherein the device has at least one base element, one compensating element, and one bearing element, wherein the bearing element is pre-mounted on one of the components,

FIG. 16 schematically shows, in section, the device according to FIG. 15 in a pre-mounted and/or assembled state,

FIG. 17 schematically shows, in section, an intermediate position of the device according to FIG. 15, in which the two components are connected to each other,

FIG. 18 schematically shows, in section, a final assembly position of the device according to FIG. 15, in which the components are set and/or compensated for at an angle to each other,

FIG. 19 schematically shows, in a perspectival view, the further embodiment of the device according to FIG. 9 for compensating for tolerances between two components to be connected to one another, wherein the device additionally has a positioning element for aligning a position of the component connected to the bearing element,

FIG. 20 schematically shows, in section, the device according to FIG. 19 in a pre-mounted and/or assembled state, in which the component connected to the bearing element is held by the positioning element in a substantially vertical or perpendicular alignment to the base element and/or compensating element,

FIG. 21 schematically shows, in section, the device according to FIG. 19 in a position adjusted and/or compensated for in its angle, wherein the component connected to the bearing element has been moved relative to the positioning element,

FIG. 22 schematically shows an exploded view of an embodiment of a bearing element for the pivotable bearing of a device for compensating for tolerances between two components to be connected to each other,

FIG. 23 schematically shows an exploded view of a further embodiment of a bearing element for the pivotable bearing of a device for compensating for tolerances between two components to be connected to each other, and

FIG. 24 schematically shows an exploded view of a further embodiment of a bearing element for the pivotable bearing of a device for compensating for tolerances between two components to be connected to each other.

### DETAILED DESCRIPTION

Parts corresponding to one another are provided with the same reference signs in all the drawings.

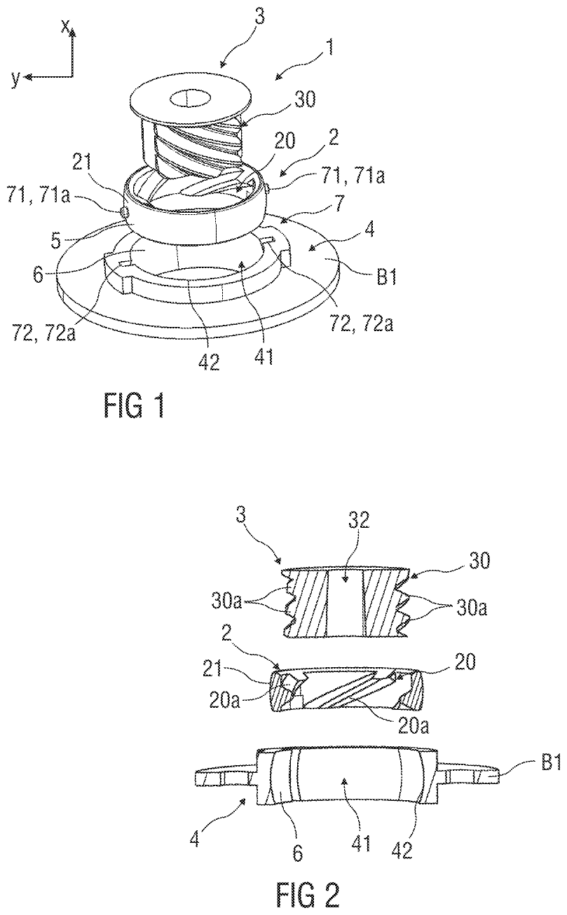

FIG. 1 schematically shows an exploded view of a device 1 for compensating for tolerances between two components B1, B2 to be connected to one another, wherein only a first component B1 is shown in FIG. 1. The device 1 for compensating for tolerances will hereafter be referred to for short as the device 1 or also as the tolerance compensation device.

For better understanding, two axes X, Y are shown, wherein the axis X represents an axial extension or an axial direction—in particular, a longitudinal extension—and the axis Y represents a radial extension or transverse direction.

The device 1 comprises at least one base element 2 and one compensating element 3. The base element 2 and the compensating element 3 are designed as hollow-cylindrical elements. The compensating element 3 can stand in or can be brought into threaded engagement with the base element 2 at a first—in particular, an inner—interface. The base element 2 comprises an internal thread 20, and the compensating element 3 comprises a corresponding external thread 30. Alternatively, the base element 2 can be arranged in the compensating element 3, and thus the base element 2 can have an outer thread and the compensating element 3 an inner thread.

The base element 2 and the compensating element 3 can be moved between an initial position and a compensation position by rotation relative to one another, and in particular can be designed to be movable axially and/or linearly relative to one another by means of the first interface.

The device 1 further comprises a bearing element 4 for pivotable positioning of the base element 2 and of the compensating element 3 arranged in the base element 2.

The base element 2 and the compensating element 3 are set up in such a way that the compensating element 3 can be moved out of its initial position axially relative to the base element 2—for example, can be moved out of the base element 2 until it reaches its compensating position, in which the base element 2 and the compensating element 3 are each in contact with one of the components B1, B2 and thus bridge the joint gap. In addition, the base element 2 and the compensating element 3 are configured such that they can be pivoted together.

For this purpose, one of the elements—in the example, the base element 2—can have a second—in particular, a common outer—interface, by means of which the base element 2 and the compensating element 3 can be mounted so as to be pivotable together. The second interface can be designed, for example, as a joint—in particular, as a ball joint—or a rotary bearing—in particular, a ball bearing.

In the exemplary embodiment shown, the base element 2 is provided on an outer circumference 21, at least in portions, with a convexly formed segment 5, which is designed in such a way that the base element 2 can be or is pivotably mounted on one of the components B1, B2—here, on component B1—for adjusting and/or compensating for an angle between the two components B1, B2. For example, the convexly formed segment 5 is a spherical segment or a spherical cap. The corresponding bearing element 4 comprises a joint segment 6. The joint segment 6 is, for example, a socket—in particular, a ball socket or a joint socket. The convexly formed segment 5 runs circumferentially over the outer circumference 21 of the base element 2. The convexly formed segment 5 is integrally formed on the outer circumference 21 of the base element 2. For example, the convexly formed segment 5 forms the outer circumference 21. The convexly formed segment 5 is integrally formed with the base element 2. The base element 2 is designed in one piece, for example, and comprises the convexly formed segment 5 on the outer circumference 21—for example, in the form of a bulge or a spherical outer surface.

The bearing element 4 comprises at least one recess 41 with a concave inner shape 42. The concave inner shape 42 forms, for example, the joint segment 6. The base element 2 can be or is arranged in the bearing element 4 so that it can pivot in a sliding manner—for example, about a horizontal axis.

The bearing element 4 can be arranged so as to be integrated into and/or on the first component B1. The bearing element 4 can be fixedly connected to the first component B1—for example, clipped, pressed, glued, or welded into it. Alternatively, the bearing element 4 can be formed in one piece with the first component B1.

In a further development, the device 1 comprises an anti-rotation device 7, which allows the base element 2 and the compensating element 3 to pivot together about a horizontal axis and prevents rotation about a longitudinal axis. The anti-rotation device 7 comprises at least one securing element 71 and one counter-securing element 72, which can be or are brought into engagement with one another. For example, two, oppositely situated securing elements 71 are arranged on the outer circumference 21 of the base element 2. The bearing element 4 comprises two, oppositely situated counter-securing elements 72. The counter-securing elements 72 are arranged, for example, in the recess 41—in particular, on the inner shape 42. The anti-rotation device 7—in particular, an active connection or active coupling of the securing elements 71 and counter-securing elements 72—is set up to hold the base element 2 non-rotatably on the components B1, B2. For example, the corresponding securing element 71 can be designed as a lug 71a or bolt projecting radially from the outer circumference 21 of the base element 2. For example, the corresponding counter-securing element 72 can be designed as a groove 72a or recess. The corresponding counter-securing element 72 extends axially at least in portions through the inner shape 42 of the bearing element 4. This makes it easier to place the securing elements 71 into the counter-securing elements 72.

The anti-rotation device 7 is, for example, an anti-rotation securing device for the base element 2 which prevents the base element 2 from moving away from the first component B1.

FIG. 2 schematically shows the exploded view according to FIG. 1 in a sectional view.

The base element 2 has an internal thread 20, which, however, is not continuous, but is formed by several thread portions 20a evenly distributed in the circumferential direction. All thread portions 20a can have the same pitch, which is chosen to be large enough that the inner thread 20 forms a steep thread. An external thread 30 is formed on an outer circumference 31 of the compensating element 3. For example, a number of groups—in the present exemplary embodiment, two groups—of screw thread portions 30a running parallel to each other can be formed so as to be distributed in the circumferential direction of the compensating element 3. The external thread 30 or the groups of thread portions 30a can be made non-continuous. A pitch of the external thread 30 can be adapted to the pitch of the internal thread 20 of the base element 2. The external thread 30 of the compensating element 3 can form a steep thread, so that the thread engagement of the base element 2 and compensating element 3 is, for example, non-self-locking.

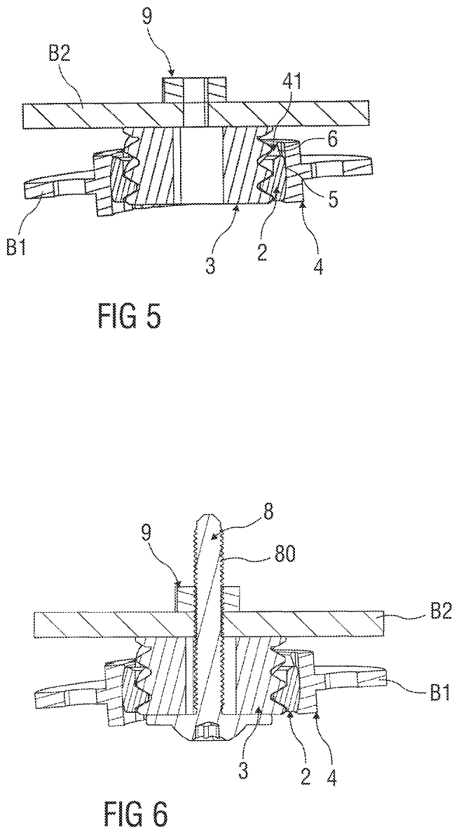

The compensating element 3 comprises a passage 32—for example, a through-hole or through-bore. The passage 32 extends axially through the compensating element 3 and serves to accommodate a connecting element 8—shown for example in FIG. 6.

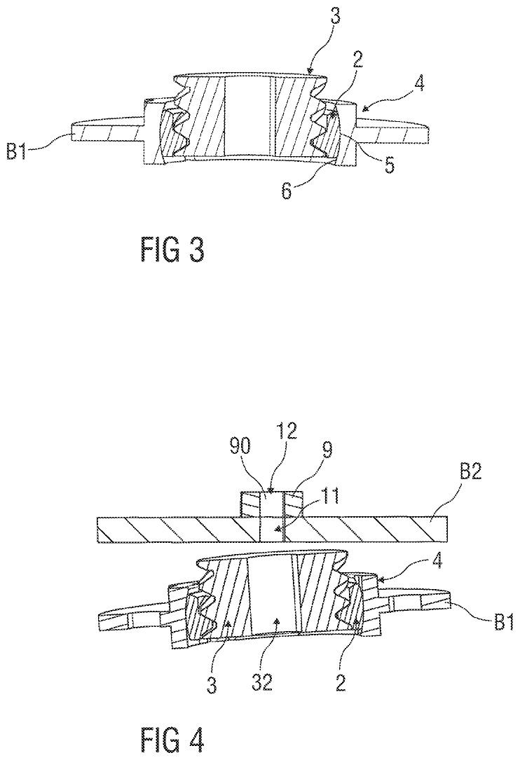

FIG. 3 is a schematic sectional view of the device 1 according to FIG. 1 in a pre-mounted and/or assembled state in which the compensating element 3 is in threaded engagement with the base element 2, and the base element 2 is pivotably connected to the bearing element 4 in a sliding manner.

FIG. 4 schematically shows a sectional view of an assembly step for aligning the device 1 according to FIG. 1 on the other of the two components B2. A fastening nut 9 is fastened to the second component B2. Passages 11, 12, e.g., through-bores or through-openings, of the component B2 and the fastening nut 9 are oriented coaxially and/or in alignment with one another. The fastening nut 9 can comprise an internal thread 90 formed in the passage 12.

FIG. 5 schematically shows a sectional view of an intermediate position of the device 1 according to FIG. 1 for connecting the two components B1, B2 and an assembly step in which an angle between the components B1, B2 is set and/or compensated for. The convexly formed segment 5 and the joint segment 6 fit together, enabling the base element 2 to pivot in a sliding manner in the recess 41 of the bearing element 4.

FIG. 6 schematically shows, in section, a final assembly position of the device according to FIG. 1, wherein both components B1, B2 are connected to each other and aligned at an angle to each other. If the first component B1 is to be screwed to the second component B2, then the first component B1 is arranged on the second component B2 together with device 1, i.e., with the base element 2 and the compensating element 3 screwed therein. The connecting element 8, having an external thread 80, is then inserted through the passage 32 of the compensating element 3 and through the passage 11 of the second component B2, and brought into threaded engagement with the fastening nut 9. The thread engagement between the base element 2 and the compensating element 3 can be non-self-locking in such a way that the compensating element 3 moves out of the base element 2 in an insertion direction or screw-in direction of the connecting element 8 when the connecting element 8 exerts an axial force acting in the insertion direction upon the compensating element 3. In the exemplary embodiment shown, the compensating element 3 can move out of the base element 2 in the direction of insertion (upwards). The base element 2 and the first component B1 can, for example, be moved away from the first component B2, or the second component B1 can be moved away from the first component B1, e.g., pushed away, by the movement of the compensating element 3 out of the base element 2. An axial tolerance compensation between the components B1, B2 can thereby take place.

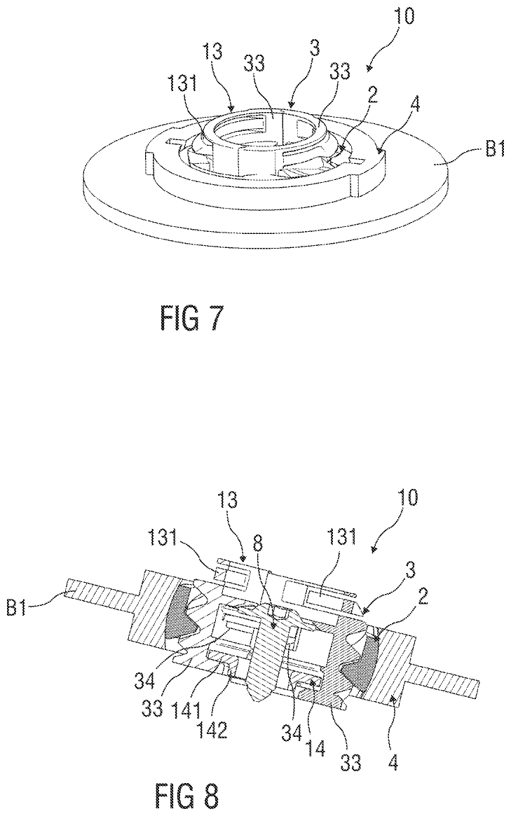

FIG. 7 schematically shows, in a perspectival view, a further embodiment of a device 10 for compensating for tolerances between two components B1, B2 to be connected to one another, wherein the device 10 has at least one base element 2, one compensating element 3, and one bearing element 4, wherein the bearing element 4 is pre-mounted on one of the components B1, B2.

The compensating element 3 is made up for example of two segments-here, in the form of hollow cylinder halves 33.

In addition, the compensating element 3 can comprise on one of its longitudinal ends a transport securing means 13 for securing the compensating element 3 and/or the hollow cylinder halves 33 in the first component B1 during a transport and before the assembly of the device 10. For example, the transport securing means 13 can be designed as a molding 131 projecting radially from the outer circumference 31 of the compensating element 3. For example, the molding 131 is formed as an annular rib or arcuate rib portions. The transport securing means 13 is integrated into—in particular, integrally formed or molded on—the compensating element 3. The transport securing means 13, e.g., in the form of the radially outward-projecting molding 131, holds the compensating element 3 in position relative to the first component B1 and to the base element 2 during transport.

FIG. 8 schematically shows, in section, the device 10 according to FIG. 7 with a pre-mounted connecting element 8. The compensating element 3 is for example composed of two segments—here, in the form of hollow cylinder halves 33—which are connected to one another by coupling elements—for example, by at least one pair of spring elements 34 axially spaced from one another. In an initial or idle state of the compensating element 3, the hollow cylinder halves 33 are arranged axially offset from one another such that a bottom half formed on the one hollow cylinder half 33 and a bottom half formed on the other hollow cylinder half 33 do not lie in one plane, but are at an certain axial offset relative to each other.

A compression limiter 14 is provided, which is arranged in the passage 32 of the compensating element 3. The compression limiter 14 can be designed in the form of a sleeve element. For example, the compression limiter 14 comprises a base part 141, which is designed in the form of a circular ring, wherein a sleeve 142 projects centrally from the base part 141. The sleeve 142 protrudes from the base part 141 in the direction away from the compensating element 3. Alternatively, the sleeve 142 can also protrude into the passage 32 of the compensating element 3 in the direction of the compensating element 3. The compression limiter 14 is designed to compensate for a tolerance between the individual components of the device 10 and to reduce stress relaxation and yield strain during assembly of the device 10.

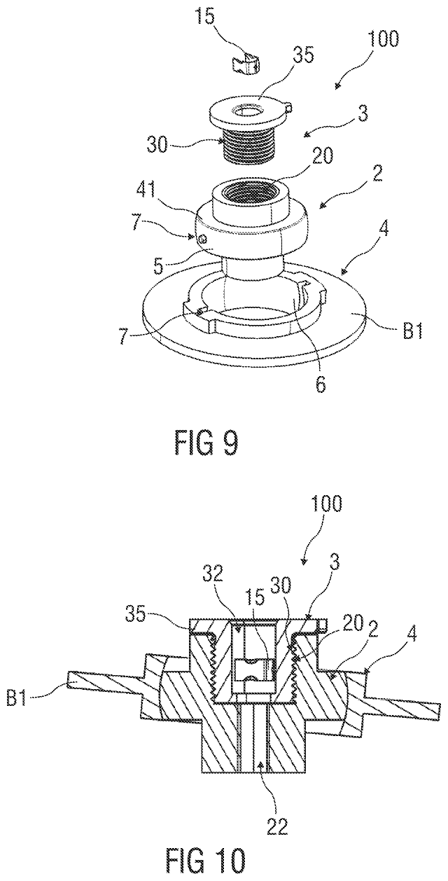

FIG. 9 schematically shows, in an exploded view, a further embodiment of a device 100 for compensating for tolerances between two components B1, B2 to be connected to one another, wherein the device 100 has at least one base element 2, one compensating element 3, and one bearing element 4, wherein the bearing element 4 is pre-mounted on one of the components B1, B2. A stop region 35 can be arranged at a longitudinal end of the compensating element 3. The stop region 35 can be designed as a disk or be disk-shaped. The disk can form an integral part of the compensating element 3, i.e., can be formed in one piece with it. In an assembled state, the compensating element 3 can be moved out of the base element 2—in particular, rotated out—via a connecting element 8, as shown in FIG. 12. The stop region 35 forms an abutment and contact region on one of the other components B1, B2.

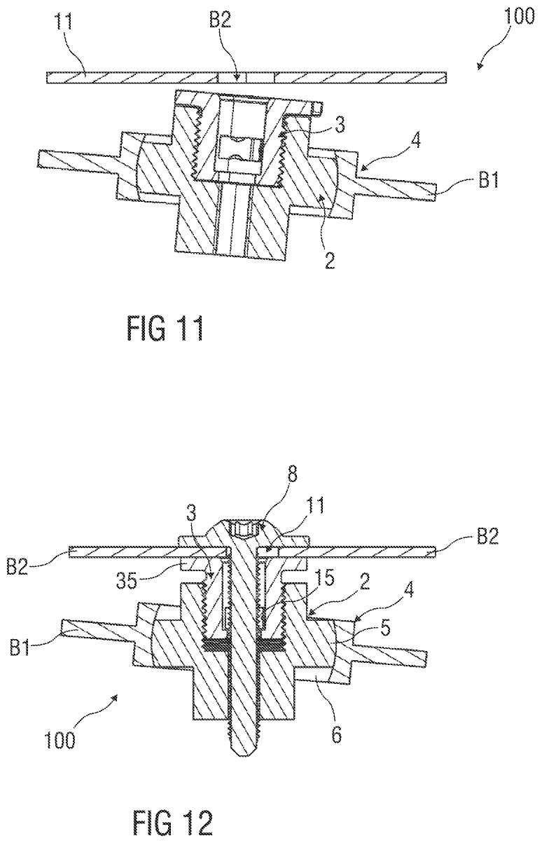

FIG. 10 schematically shows, in section, the device 100 according to FIG. 9 in a pre-mounted and/or assembled state. FIG. 11 schematically shows, in section, an assembly step for aligning the device 100 according to FIG. 9 with the other of the two components B1, B2. FIG. 12 schematically shows, in section, a final assembly position of the device 100 according to FIG. 9, wherein both components B1, B2 are connected to each other and aligned at an angle to each other.

In the embodiment shown, the device 100 is arranged between the components B1, B2 in order to connect—in particular, screw together—the two components B1, B2, and the connecting element 8 is passed from above through a passage 11, e.g., an opening, in the second component B2 and the device 100—in particular, through a passage 22 of the base element 2. The connecting element 8, e.g., a screw, comes into engagement with a driver element 15 arranged in the passage 32 of the compensating element 3. If the screw element 8 for screwing the components B1, B2 together is rotated in the screw-in direction or direction of insertion, a torque is transmitted to the compensating element 3 by the driver element 15, which torque causes a rotation of the compensating element 3 relative to the base element 2, as a result of which the compensating element 3 moves upwards out of the base element 2 along a central longitudinal axis. This allows an axial tolerance compensation to take place. An angle between the components B1, B2 can then be set and/or compensated for. The convexly formed segment 5 and the joint segment 6 fit together, enabling the base element 2 to pivot in sliding fashion in the recess 41 of the bearing element 4.

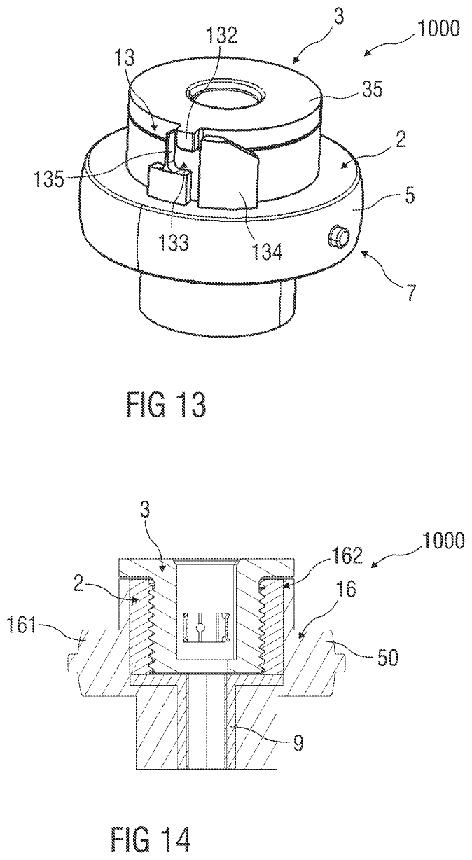

FIG. 13 schematically shows, in a perspectival view, a further embodiment of a device 1000 for compensating for tolerances between two components B1, B2 to be connected to one another, wherein the device 1000 has at least one base element 2, one compensating element 3, and one transport securing means 13. At one of its longitudinal ends, the compensating element 3 can comprise at least one transport securing means 13 for securing the compensating element 3 to the base element 2 and/or to a convex outer circumference 21 of the base element 2 and/or to a convexly formed segment 5 on the base element 2. In a transport state, the compensating element 3 and the base element 2 can be completely or almost completely screwed to one another. A stop region 35 can be formed at an end, facing away from the base element 2—in particular, a longitudinal end—of the compensating element 3. For example, a lug 132 can be formed on the compensating element 3 and/or on the stop region 35 of the compensating element 3, wherein, in the transport state, the lug 132 can engage in a corresponding opening 133 in and/or on the base element 2. The opening 133 can be formed by a protruding end stop 134 and a protruding transport securing element 135. The transport securing element 135 prevents unintentional rotation of the compensating element 3 in relation to the base element 2. The transport securing element 135 can be flexible in design and, with a screw force applied to the compensating element 3, can be deformed, e.g., bent away, by the lug 132. The compensating element 3 can thus be screwed out of the base element 2 after a defined torque or a defined force has been overcome. The end stop 134 can be provided to prevent an over-rotation of the compensating element 3 relative to the base element 2 in the transport state.

FIG. 14 schematically shows, in section, the device 1000 according to FIG. 13 with a separate retaining ring 16. In the embodiment shown, the base element 2 is provided with a separate retaining ring 16—in particular, fixedly connected. The retaining ring 16 comprises a convexly formed segment 50, which is designed in such a way that the base element 2 can be pivotably mounted together with the compensating element 3 on one of the components B1, B2. The retaining ring 16 comprises a convex outer shape 161. The convex outer shape 161 can accordingly form a convexly formed segment 50. The retaining ring 16 has a cylindrical receiving space 162 which corresponds to the outer circumference 21 of the base element 2. The base element 2 can be pressed into the retaining ring 16. Some other force-fitting, positive-fitting, and/or materially bonded connection may also be used.

The base element 2 can be realized in multiple parts. Thus, the actual base element 2, e.g., with internal thread 20, can be a separate component, which in turn can be or is mounted in the retaining ring 16. The retaining ring 16 has a spherical outer surface or a spherical segment or ball joint. For example, the base element 2 can be made of metal—for example, steel. The retaining ring 16 can be made of plastic. In other words, the convexly formed segment 50, e.g., a joint head, can be made of plastic. A fastening nut 9 can also be a separate component. For example, a fastening nut 9 is arranged in the receiving space 162 of the retaining ring 16, e.g., pressed—in particular, pressed in.

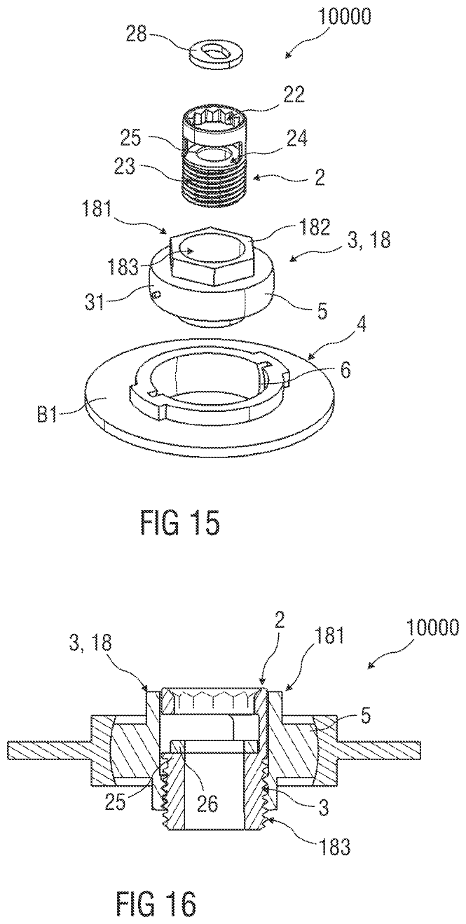

FIG. 15 schematically shows, in an exploded view, a further embodiment of a device 10000 for compensating for tolerances between two components B1, B2 to be connected to one another, wherein the device 10000 has at least one base element 2, one compensating element 3, and one bearing element 4, wherein the bearing element 4 is pre-mounted on one of the components B1, B2. In the exemplary embodiment shown, the compensating element 3 is provided with a convexly formed segment 5. In this case, an outer circumference 31 of the compensating element 3 can be provided with the convexly formed segment 5.

The base element 2 is clamped to the other of the components B1, B2 by a connecting element 8, e.g., by means of a screw, as shown in FIG. 18. By rotating the compensating element 3, a distance, e.g., axial distance, of the components B1, B2 relative to one another can be adjusted. Due to the common pivotable mounting of the base element 2 and the compensating element 3 in the bearing element 4, e.g., in the form of a so-called ball joint connection, the first component B1 can be aligned at an angle to the second component B2 in order to compensate for angular errors. Depending upon the design of the device 10000, not only can an angular error between the two components B1, B2 be compensated for, but an angle of rotation can also be set using a specific pivot point 17, as indicated in FIG. 18. For example, by adjusting the axial distance between the components B1, B2, the angle of rotation between these can also be set.

In the exemplary embodiment shown, the general idea is based upon fastening the components B1, B2 using the device 10000 in such a way that the compensating element 3, which here forms an adjusting element 18, does not have to be supported on the second component B2. A further advantage of the device 10000 is that the device 10000 consists of only a few components, as a result of which it can be produced in a simple and cost-effective manner. The simple design means that the device 10000 is easy to operate, in that a position of the first component B1 relative to the second component B2 can be adjusted by simply rotating the compensating element 3, which is designed as adjusting element 18, relative to the base element 2. Furthermore, the compensating element 3 is continued as adjusting element 18.

The base element 2 is provided on its outside with a base element thread 23. The adjusting element 18 can be designed in the manner of a screw nut. The adjusting element 18 has an adjusting element thread 183 on its inner side. In the assembled state, the base element 2 is in threaded engagement with the adjusting element 18 via the base element thread 23 and the adjusting element thread 183. In principle, for this purpose, the base element 2 can have an internal thread 20, and the adjusting element 18 can have an external thread.

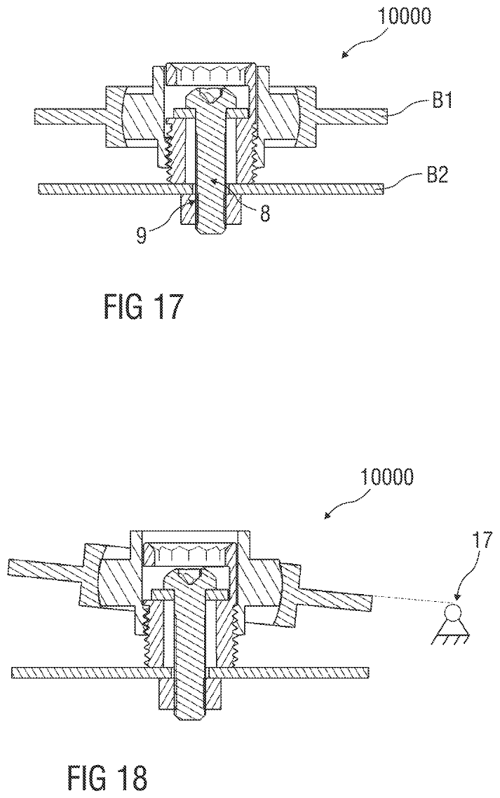

Despite self-locking of the threaded engagement between the base element 2 and the adjusting element 18, it should be possible to deliberately adjust the position of the adjusting element 18 relative to the base element 2, and thus ultimately the position of the first component B1 relative to the second component B2. For this purpose, the adjusting element 18 comprises at least one engagement feature 181—in particular, for a tool-so that the adjusting element 18 can be rotated via the engagement feature 181 and thus the position can be adjusted relative to the base element 2, as shown in FIGS. 17 and 18. For example, the engagement feature 181 can be arranged on an outer lateral surface and/or at a longitudinal end of the adjusting element 18. The engagement feature 181 can be designed, for example, in the form of a prismatic—in particular, a quadrangular or hexagonal-outer contour of the outer lateral surface and/or of the longitudinal end, so that a wrench can be brought into engagement with the engagement feature 181 for the purpose of rotating. In the exemplary embodiment shown, a projection 182 is formed at a longitudinal end of the adjusting element 18, the outer contour of which projection is a hexagon.

The base element 2 has a passage 22 on its inner side. On the inside of the passage 22, a constriction 24 can project radially inwards, which forms a stop surface 25 on the side facing away from the second component B2. The passage 22 is dimensioned in such a way that both a connecting element 8 and optionally a washer 26, which can rest on the stop surface 25, as well as a suitable tool (not shown) for adjusting the connecting element 8 can be accommodated in its interior. The connecting element 8, together with a fastening nut 9, which is formed on or fastened to the second component B2, acts as connecting means for fixing the base element 2 to the second component B2.

FIG. 16 schematically shows, in section, the device 10000 according to FIG. 15 in a pre-mounted and/or assembled state. FIG. 17 shows a schematic sectional view of an intermediate position of the device 10000 according to FIG. 15, in which the two components B1, B2 are connected to each other, and the base element 2 is fixed to the second component B2. FIG. 18 schematically shows, in section, a final assembly position of the device 10000 according to FIG. 15, in which the components B1, B2 are set and/or compensated for at an angle to each other. The pivot point 17 can be fastened at a fastening point to the second component B2 or to another component. The first component B1 can additionally be pivoted, e.g., tilted, relative to the second component B2 by rotating the adjusting element 18.

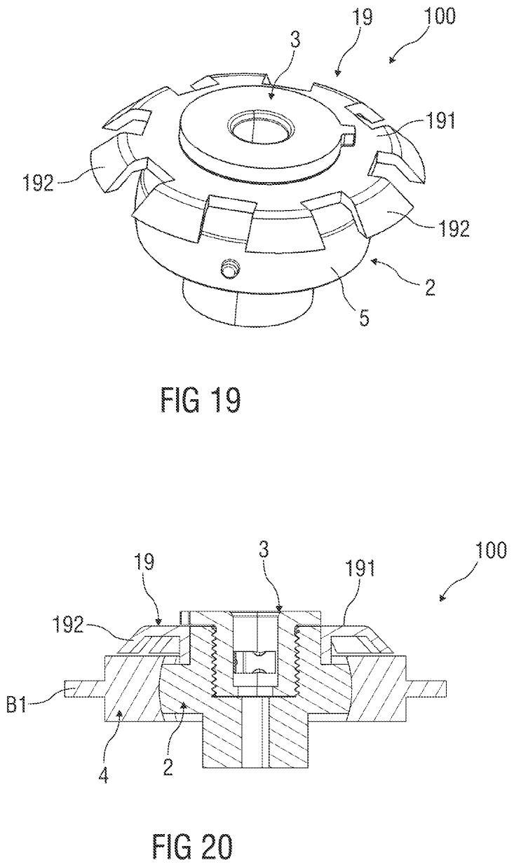

FIG. 19 schematically shows, in a perspectival view, the further embodiment of the device 100 according to FIG. 9 for compensating for tolerances between two components B1, B2 to be connected to one another, wherein the device 100 additionally has a positioning element 19 for aligning a position of the component B1 connected to the bearing element 4. The positioning element 19 comprises an annular positioning body 191, which surrounds the outer circumference 21 of the base element 2 in a region above the convexly formed segment 5. The positioning body 191 comprises a plurality of positioning arms 192 which project radially from the positioning body 191. The positioning element 19 is provided in order to ensure that the component B1 is supplied at right angles to the interface, i.e., to the second component B2. The positioning element 19 can form a flexible stop. The positioning arms 192 can be designed as hard end stops, which can limit a maximum angle to the first component B1. The positioning arms 192 can also be part of the base element 2 or of the compensating element 3 or can be mounted on these.

FIG. 20 schematically shows, in section, the device 100 according to FIG. 19 in a pre-mounted and/or assembled state, in which the component B1 connected to the bearing element 4 is held by the positioning element 19 in a substantially vertical or perpendicular alignment to the base element 2 and/or compensating element 3.

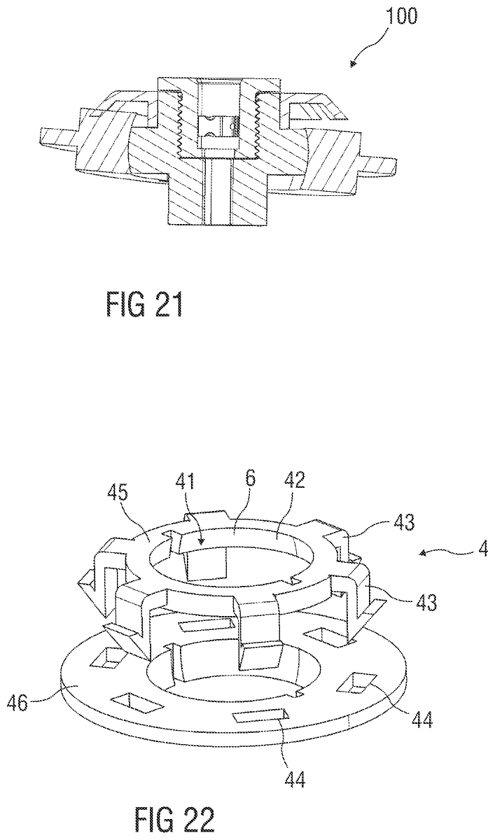

FIG. 21 schematically shows, in section, the device 100 according to FIG. 19 in a position adjusted and/or compensated for in its angle, wherein the component B1 connected to the bearing element 4 has been moved relative to the positioning element 19. The positioning arms 192 can be of flexible design.

FIG. 22 schematically shows an exploded view of an embodiment of a bearing element 4 for the pivotable bearing of a device 1, 10, 100, 1000, 10000 for compensating for tolerances between two components B1, B2 to be connected to each other. The bearing element 4 comprises a plurality of latching hooks 43 which project radially outwards from the recess 41. The latching hooks 43 can be inserted into corresponding latching recesses 44 and come into engagement therewith. The bearing element 4 can be designed in two parts, for example. For example, the bearing element 4 can have a bearing body 45 with the recess 41, the inner shape 42, and the latching hooks 43. In addition, the bearing element 4 can have a bearing base 46, wherein the latching recesses 44 are arranged in the bearing base 46. The bearing components connected to one another can be pre-mounted on a component B1. A component B1 can also be provided with the corresponding latching recesses 44.

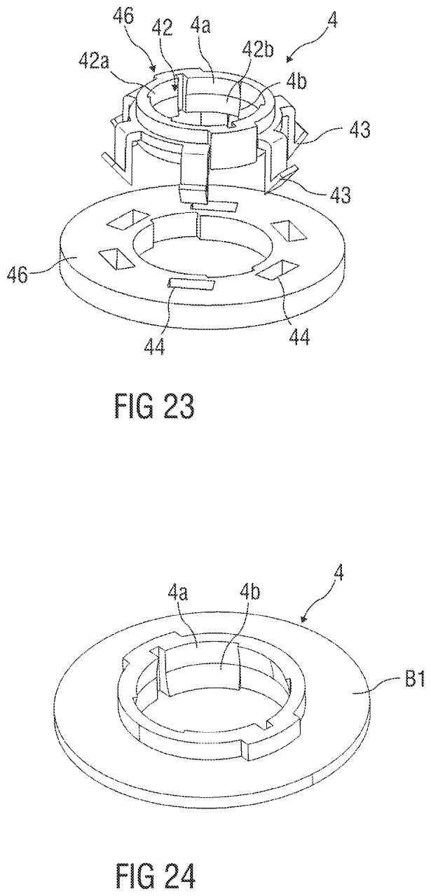

FIG. 23 schematically shows an exploded view of an embodiment of a bearing element 4 for the pivotable bearing of a device 1, 10, 100, 1000, 10000 for compensating for tolerances between two components B1, B2 to be connected to each other. The bearing element 4 can consist of two bearing halves 4a, 4b. Each of the bearing halves 4a, 4b can have an inner shape half 42a, 42b, which, in the assembled state of the bearing element 4, form a concave inner shape 42. For example, one of the bearing halves 4a, 4b can have latching hooks 43. In addition, the bearing element 4 can have a bearing base 46, wherein corresponding latching recesses 44 are arranged in the bearing base 46. The bearing components connected to one another can be pre-mounted on a component B1. A component B1 can also be provided with the corresponding latching recesses 44.

FIG. 24 schematically shows an exploded view of a further embodiment of a bearing element 4 for the pivotable mounting of a device 1, 10, 100, 1000, 10000 for compensating for tolerances between two components B1, B2 to be connected to one another. The bearing element 4 can consist of two bearing halves 4a, 4b, which, for example, each represent an upper shell and a lower shell.

### LIST OF REFERENCE SIGNS

1, 10, 100, 1000, 10000 Device
2 Base element
20 Internal thread
20a Thread pitch portion
21 Outer circumference
22 Passage
23 Base element thread
24 Narrowing
25 Stop surface
26 Washer
3 Compensating element
30 External thread
30a Thread pitch portion
31 Outer circumference
32 Passage
33 Hollow cylinder half
34 Spring element
35 Stop region
4 Bearing element
4a, 4b Bearing half
41 Recess
42 Inner shape
42a, 42b Inner shape half
43 Latching hook
44 Latching recess
45 Bearing body
46 Bearing base
5, 50 Segment
6 Joint segment
7 Anti-rotation device
71 Securing element
71a Lug
72 Counter-securing element
72a Groove
8 Connecting element
80 External thread
9 Fastening nut
90 Internal thread
11 Passage
12 Passage
13 Transport securing means
131 Molding
132 Lug
133 Opening
134 End stop
135 Transport securing element
14 Compression limiter
141 Base part
142 Sleeve
15 Driver element
16 Retaining ring
161 Outer shape
162 Receiving space
17 Pivot point
18 Adjusting element
181 Engagement feature
182 Projection
183 Positioning element thread
19 Positioning element
191 Positioning body
192 Positioning arms
B1, B2 Component
X, Y Axis

What is claimed:

1-10. (canceled)

11. A device for compensating for tolerances between two components to be connected to one another, comprising:
a hollow-cylindrical base element and
hollow-cylindrical compensating element which can be brought or is brought into threaded engagement with the base element,
wherein the base element and the compensating element are set up such that they can be moved relative to one another between an initial position and a compensating position and can optionally be pivoted with one another.

12. The device according to claim 11, wherein the base element or the compensating element is provided on an outer circumference at least in portions with a convexly formed segment which is designed such that the base element or the compensating element is pivotably mountable or mounted on one of the components.

13. The device according to claim 12, wherein the convexly formed segment is integrally formed on the outer circumference of the base element or on the outer circumference of the compensating element.

14. The device according to claim 11, wherein the base element or the compensating element is provided with a separate retaining ring which has a convexly formed segment and is designed such that the base element or the compensating element is pivotably mountable or mounted on one of the components.

15. The device according to claim 11, wherein at least one bearing element is provided by which the base element or the compensating element can be arranged or is arranged in a sliding manner on one of the components.

16. The device according to claim 15, wherein the bearing element has at least one recess with a concave inner shape for pivotable connection to the base element or the compensating element.

17. The device according to claim 15, wherein at least one connection element is provided which can be inserted through the base element and the compensating element in order to connect the two components.

18. The device according to claim 15, wherein an outer circumference of the base element or an outer circumference of the compensating element is provided with at least one securing element which is designed to hold the base element or the compensating element on one of the components in a non-rotatable manner.

19. The device according to claim 18, wherein the at least one securing element protrudes radially from the outer shape or from the outer circumference of the base element or the compensating element.

20. The device according to claim 18, wherein the bearing element has at least one counter-securing element which is arranged on an inner shape of the bearing element and is designed to come into engagement with the securing element.

21. The device according to claim 11, wherein at least the compensating element at one of its longitudinal ends comprises at least one transport securing means for securing the compensating element to the base element.
